(19) United States
(12) Patent Application Publication
(10) Pub. No.: US 2018/0283059 A1
(43) Pub. Date: Oct. 4, 2018

(54) SAFETY DEVICE FOR CLOSURES

(71) Applicant: Puertas Roper S.L., Maliano (ES)

(72) Inventor: Mounir Maamar Eljannan, Maliano (ES)

(21) Appl. No.: 15/941,706

(22) Filed: Mar. 30, 2018

(30) Foreign Application Priority Data
Mar. 30, 2017 (ES) U 201700229

(51) Int. Cl. E05C 1/02; E05C 1/00

(52) U.S. Cl. CPC E05C 1/02; E05C 1/002

(57) ABSTRACT

A safety device for closures that comprises, a casing (6) that can be fastened in a closure, a bolt (4) that is movable inside the casing (6), a stop (4.1) that is integral to the bolt (4), a seal (2) arranged in a fixed manner with respect to the casing (6), a spring (5) in contact with the stop (4.1) and arranged in a compressed manner in the casing (6) due to the effect of the seal (2); wherein the seal (2) is made of a material that is configured to change state at a preset temperature, such that when it changes state, the spring (5) is free to move the bolt (4), passing through the seal (2) until it projects outside the casing (6).

### CROSS REFERENCE TO RELATED APPLICATION

This application claims the benefit of priority from Spanish Patent Application No. U201700229 filed Mar. 30, 2017, which is incorporated herein by reference

### TECHNICAL FIELD

The object of this utility model is a safety device for closures, such as doors, windows or similar elements. In order to make the description simpler, we will refer henceforth to doors, understanding that the application is possible for closures in general.

### STATE OF THE ART

Specifically in the case of doors referred to as fire doors, there are circumstances in which, when there is a fire, the door should be locked to prevent the opening thereof from enabling the fire to spread to other rooms and this is the object of the present invention.

Currently complex systems that use sensors, either temperature or smoke, to detect fires are known. These systems additionally include electronic units that receive signals from these sensors in order to, in accordance therewith, control electromagnetic devices that prevent the opening of doors.

These systems, in addition to a high cost due to the use of numerous and complex elements, have a high risk of not working correctly due to the complex interaction between all the elements. This risk further increases when environments that reach high temperatures are involved.

Therefore, a solution that is effective in preventing a closure from being opened when there is a fire is necessary.

### OBJECT OF THE INVENTION

In order to fulfil this aim and resolve the aforementioned technical problems to date, in addition to providing additional advantages that can be derived later, the present invention relates to a safety device for closures that effectively prevents the opening thereof when there is a fire.

The safety device for closures of the invention comprises a casing that can be fastened in a closure; a bolt that is movable inside the casing; a stop that is integral to the bolt; a seal arranged in a fixed manner with respect to the casing; and a spring in contact with the stop and arranged in a compressed manner in the casing due to the effect of the seal. The seal is made of a material that is configured to change state at a preset temperature, such that when it changes state, the spring is free to move the bolt, passing through the seal until it projects outside the casing.

Therefore, the safety device is made up of the bolt that, due to the effect of the spring, is kept in a non-operational stable position, wherein said bolt acts against the seal that keeps it in this position, wherein the bolt does not operate and is simply arranged, at least partially, inside the housing casing.

The seal is made of an intumescent material capable of resisting for a period of time the high temperatures that arise in a fire, but when it reaches a preset temperature range, the seal changes state and changes to a semi-soft state, in which the bolt is capable of passing through it due to the elastic effect of the spring. The preset temperature in this regard is preferably at least 200° C.

The safety device comprises an upper flange, a lower flange and first rivets, such that the seal is arranged held between the upper flange and the lower flange by means of the first rivets.

The safety device can additionally comprise second rivets and through holes in the upper flange, such that the safety device can be fastened in the closure by the second rivets being arranged through the through holes.

When the bolt passes through the seal, the bolt moves longitudinally, changing to a position wherein one of the ends thereof projects to the outside with respect to the housing casing and thus changes to an operational stable position wherein it can penetrate in a strike, preventing the door from opening.

In this way, in the event of a fire, the door that incorporates the safety device object of this invention automatically, and when a preset temperature range is reached, locks in a closed position.

### DESCRIPTION OF THE DRAWINGS

FIG. 1 shows a perspective view of a safety device object of the present invention, according to an exemplary embodiment.

FIG. 2 is another perspective view of the safety device of FIG. 1.

FIGS. 3, 4 and 5 are elevation, profile and plan views, respectively, of the safety device shown in FIGS. 1 and 2.

FIG. 6 shows a perspective and exploded view of different components of the safety device object of the present invention.

FIG. 7 is a cross-sectional view showing the safety device mounted in a door and in a non-operational position.

FIG. 8 is a cross-sectional view showing the safety device in an operational position to fulfil a locking function.

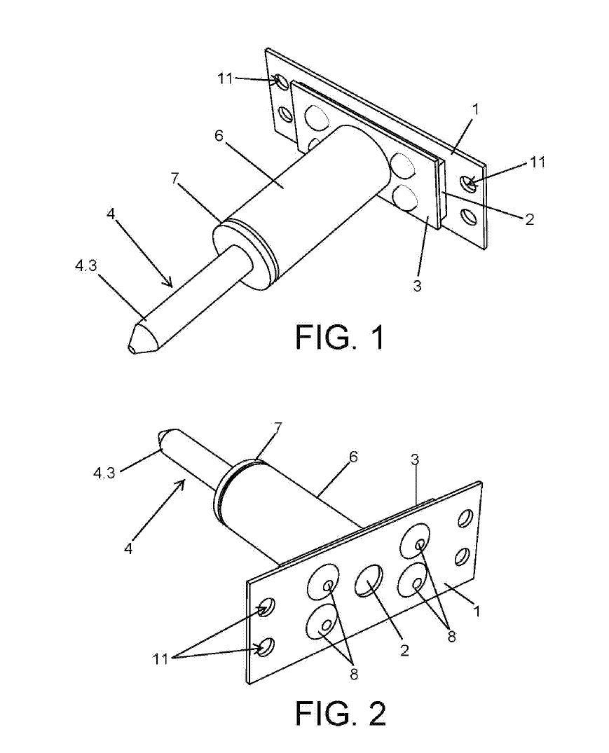

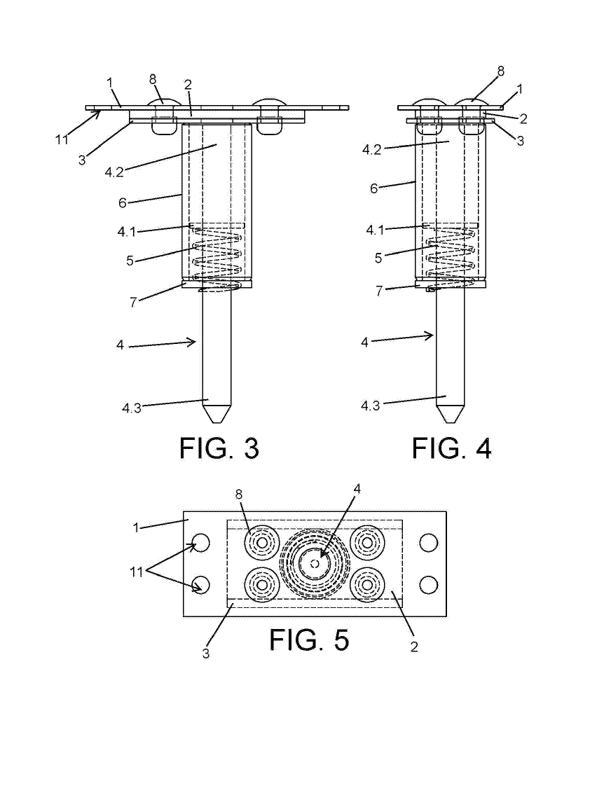

### DETAILED DESCRIPTION OF THE INVENTION

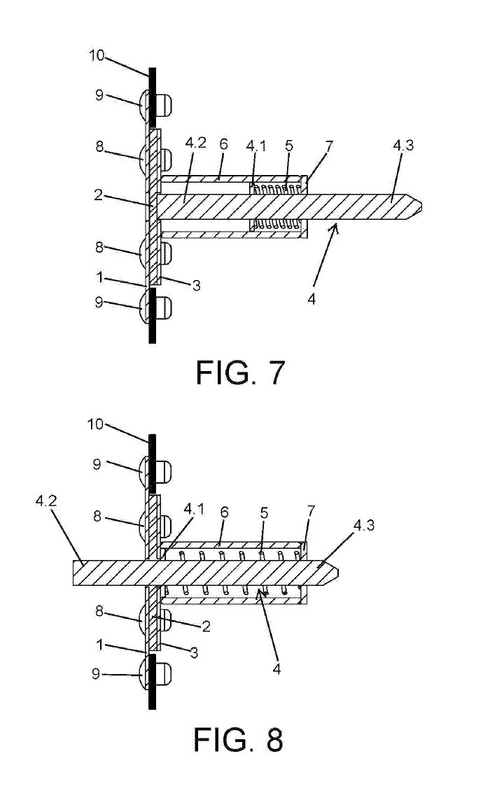

The safety device advocated herein essentially constitutes a bolt (4), which is at least partially housed inside a casing (6) and which, due to the effect of an elastic element or spring (5), is kept in a stable position wherein it acts against a seal (2), as shown in FIG. 7.

In the event of a fire and when a preset temperature is reached, the seal (2) changes from a solid state to a semi-soft state. As a result of this change of state of the seal (2), wherein the bolt (4) is capable of passing through the seal (2), due to the effect of the compressed spring (5), as shown in FIG. 8, in order for a front end (4.2) of the bolt (4) to project to the outside of the casing (6) and penetrate into a strike, not shown, thus fulfilling lock functions of a door (10), wherein the safety device is mounted.

In this way, if this safety device is incorporated, for example, in a door that is referred to as a fire door, indicated with reference number (10) in FIG. 7, the bolt (4) remains stable in the locked position that is shown in said FIG. 7, wherein it does not fulfil any function, that is, it is in a non-operational stable position. In the event there is a fire and the seal (2) reaches a preset temperature, the bolt (4) passes through the seal (2) and the front end (4.2) thereof projects to the outside, automatically locking the door (10), in order to prevent the opening thereof and the fire from spreading.

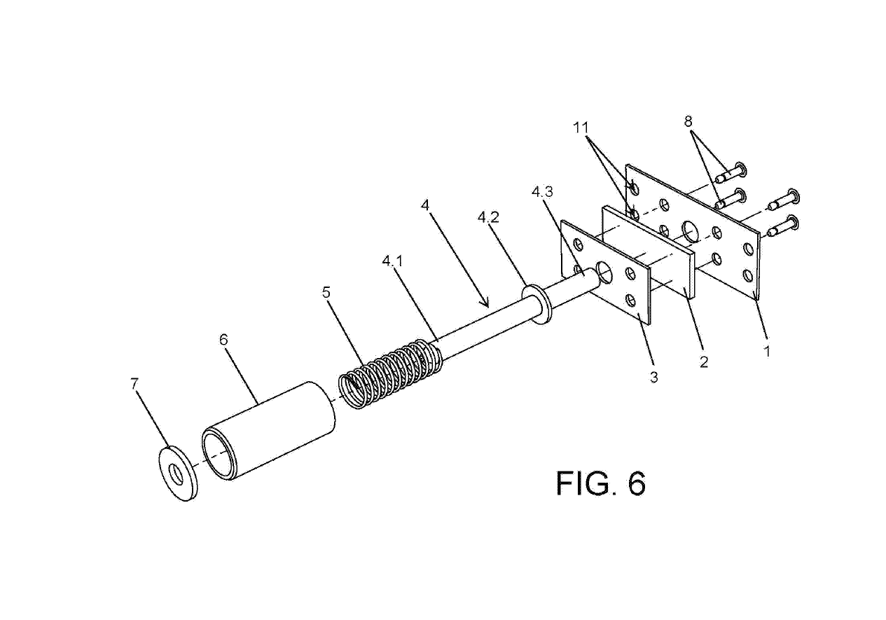

FIG. 6 represents an exploded view showing a practical exemplary embodiment of the device object of this invention. This practical exemplary embodiment must not be understood in a limiting sense.

According to this practical embodiment, the bolt (4) incorporates, integral thereto, a stop (4.1), the spring (5) being compressed between the stop (4.1) and the back of the casing (6), as seen in FIG. 7. The stop (4.1), which keeps the spring (5) compressed while the seal (2) is in the solid state, can be determined by a washer that is integral to the bolt (4) or by protrusions, obtained for example by deforming the bolt (4) itself, or by any other form that enables the described function of a stop for the spring (5) to be fulfilled.

The housing casing (6), also as a simple exemplary embodiment, constitutes a bushing that at one end is welded to a lower flange (3) and at the other end is welded to a washer (7), through which a rear end (4.3) of the bolt (4) projects acting as a guide. Logically, and without altering the essence of the invention in any way, the casing (6) can be formed according to other embodiments, which enable the bolt (4) and the spring (5) to be housed.

The lower flange (3) is arranged joined, by means of riveting, to an upper flange (1), between which the seal (2) is held, which in turn fulfils the functions of a stop for the bolt (4).

The join between the flanges (1) and (3) is carried out by means of first rivets (8), shown in FIG. 6. Likewise, the mounting of the safety device in the corresponding door (10) is moreover carried out by second rivets (9) that pass through respective through holes (11) only of the upper flange (1).

Logically, both the join between the flanges (1) and (3) and the mounting of the device in the door (10), can be carried out by any other conventional attachment solution that is different from the first and second rivets (8, 9), without the essence of the invention being altered.

The seal (2) constitutes, for example, an intumescent material that, at room temperature, behaves like a solid seal, fulfilling the functions of a stop for the bolt (4) and that can even withstand high temperatures in the event of a fire, but that, when a preset temperature range is reached, for example when approximately 200° C. is reached, the material constituting the seal (2) changes from solid state to semi-soft state, wherein the bolt (4) can pass through the same due to the force exerted by the spring (5).

The seal (2) can constitute any material capable of having said characteristic of withstanding for a period of time the high temperatures that arise in a fire, maintaining the solid state thereof and only when a certain preset temperature is reached, the constituting material thereof changes from solid state to semi-soft, or less solid, state, wherein the safety device must then act.

1. A safety device for closures, comprising:
a casing that can be fastened in a closure;
a bolt that is movable inside the casing;
a stop that is integral to the bolt;
a seal arranged in a fixed manner with respect to the casing;
a spring in contact with the stop and arranged in a compressed manner in the casing due to the effect of the seal;
wherein the seal is made of a material that is configured to change state at a preset temperature, such that when it changes state, the spring is free to move the bolt, passing through the seal until it projects outside the casing.

2. The safety device according to claim 1, wherein the seal is made of intumescent material.

3. The safety device according to claim 1, wherein the preset temperature is at least 200° C.

4. The safety device according to claim 1, comprising an upper flange, a lower flange and first rivets, such that the seal is arranged held between the upper flange and the lower flange by means of the first rivets.

5. The safety device according to claim 4, comprising second rivets and through holes in the upper flange, such that the safety device can be fastened in the closure by the second rivets being arranged through the through holes.
